(19) United States
(12) Patent Application Publication
(10) Pub. No.: US 2006/0056540 A1
(43) Pub. Date: Mar. 16, 2006

(54) Dynamic pilot subcarrier and data subcarrier indexing structure for wireless MIMO communication systems

(75) Inventor: David P. Magee, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated., Dallas, TX (US)

(21) Appl. No.: 11/226,039

(22) Filed: Sep. 14, 2005

Related U.S. Application Data
(60) Provisional application No. 60/609,899, filed on Sep. 14, 2004.

(51) Int. Cl. H04B 7/06

(52) U.S. Cl. 375/299

(57) ABSTRACT

The present invention provides a subcarrier index coordinator for use with a multiple-input, multiple-output (MIMO) transmitter having N transmit antennas, N being at least two, wherein each employs a plurality of transmit symbols with used subcarriers. The subcarrier index coordinator includes a subcarrier index generator configured to generate a set of pilot subcarrier indices and a set of data subcarrier indices for transmission. Additionally, the subcarrier index coordinator also includes a subcarrier index formatter coupled to the subcarrier index generator and configured to arrange the sets of pilot subcarrier indices and data subcarrier indices within the used subcarriers during transmission based on the N transmit antennas and the plurality of transmit symbols.

### CROSS-REFERENCE TO PROVISIONAL APPLICATION

This application claims the benefit of U.S. Provisional Application No. 60/609,899 entitled “Dynamic Pilot Tone and Data Tone Indexing Structure for Wireless MIMO Communication Systems” to David P. Magee, filed on Sep. 14, 2004, which is incorporated herein by reference in its entirety.

### TECHNICAL FIELD OF THE INVENTION

The present invention is directed, in general, to communication systems and, more specifically, to a subcarrier index coordinator, a method of coordinating subcarrier indices and a MIMO communication system employing the coordinator or the method.

### BACKGROUND OF THE INVENTION

The capacity and reliability of communication systems is a focus that is increasingly driving much of systems technology. Employing multiple-input, multiple-output (MIMO) communication systems is an area that supports this growth in the development of wireless networks. MIMO communication systems have been shown to provide improvements in both capacity and reliability over single-input, single-output (SISO) communication systems. These MIMO communication systems commonly employ a block structure wherein a MIMO transmitter (which is a cooperating collection of N single-dimension transmitters) sends a vector of symbol information. This symbol vector may represent one or more coded or uncoded SISO data symbols. A MIMO receiver (which is a cooperating collection of M single-dimension receivers, (M>N) receives one or more copies of this transmitted vector of symbol information. The performance of the entire communication system hinges on the ability of the receiver to find reliable estimates of the symbol vector that was transmitted by the transmitter. This necessitates that the MIMO receiver provide reliable channel estimates associated with transmissions from the MIMO transmitter.

For example, a 2×2 MIMO communication system may transmit two independent and concurrent signals, employing two single-dimension transmit antennas and two single-dimension receive antennas. Alternatively, the antennas could be derived from a single physical antenna that appropriately employs polarization. Two receive signals Y1(k), Y2(k) on the k^{th} sub-carrier/tone following a Fast Fourier Transformation and assuming negligible inter-symbol interference may be written as:
Y1(k)=H₁₁(k)*X1(k)+H₁₂(k)*X2(k)+n1(k)
Y2(k)=H₂₁(k)*X1(k)+H₂₂(k)*X2(k)+n2(k)
where X1(k) and X2(k) are two independent signals transmitted on the k^{th} sub-carrier/tone from the first and second transmit antennas, respectively, and n1 and n2 are noises associated with the two receive signals. The term Hᵢⱼ(k), where i=1,2 and j=1,2, incorporates gain and phase distortion associated with symbols transmitted on the k^{th} sub-carrier/tone from transmit antenna j to receive antenna i. The channel gain and phase terms Hᵢⱼ(k) may also include gain and phase distortions due to signal conditioning stages such as filters and other analog electronics. The receiver is required to estimate the channel values Hᵢⱼ(k) to reliably decode the transmitted signals X1(k) and X2(k).

To estimate the channel coefficients Hᵢⱼ(k) at the receiver, the transmitter and the receiver typically employ initial training sequences. These training sequences are predefined and known at both the transmitter and the receiver. In an IEEE 802.11(a) compliant system, a training sequence (called a long sequence) is employed as part of a preamble to the transmission of data. This long sequence involves the transmission of a known sequence of vector symbols, employing 52 excited tones (1 or −1), an unexcited tone (0) at DC and unexcited tones at each end of the spectrum, to provide guard bands that are used to protect data tones from pass band filter effects.

In nomadic environments (or fixed environments with dynamic interferers), the channel characteristics change more frequently than the current channel estimation process. Additionally, established channel estimates may be subject to depreciating influences during data transmission due to differences in sampling clocks and carrier frequencies associated with the transmitting and receiving systems. Pilots having standard frequencies are also transmitted along with data to provide a refinement of channel estimation. However, existing pilot structures use only static locations that are designed for fixed wireless environments and rely on interpolation between the pilots to obtain necessary information for channel estimation, as well as phase correction and noise variance estimation at the intermediate frequency locations.

In existing SISO OFDM wireless communication systems, pilots are located at fixed subcarriers indices such as in IEEE 802.11a/b/g systems or may occupy different positions in a series of predefined subcarrier indices during a sequence of symbols such as in DVB-H. Such a pilot structure cannot detect nulls or gains in the channel profile if there is not a pilot close enough to the attenuated subcarrier, since channel interpolation uses weighted averages associated with the fixed pilots, which do not reflect the changing channel environment.

Accordingly, what is needed in the art is an enhanced way to employ pilot signals to improve the performance of MIMO communication systems, especially in nomadic environments.

### SUMMARY OF THE INVENTION

To address the above-discussed deficiencies of the prior art, the present invention provides a subcarrier index coordinator for use with a multiple-input, multiple-output (MIMO) transmitter having N transmit antennas, N being at least two, wherein each employs a plurality of transmit symbols with used subcarriers. The subcarrier index coordinator includes a subcarrier index generator configured to generate a set of pilot subcarrier indices and a set of data subcarrier indices for transmission. Additionally, the subcarrier index coordinator also includes a subcarrier index formatter coupled to the subcarrier index generator and configured to arrange the sets of pilot subcarrier indices and data subcarrier indices within the used subcarriers during transmission based on the N transmit antennas and the plurality of transmit symbols.

In another aspect, the present invention provides a method of coordinating subcarrier indices for use with a multiple-input, multiple-output (MIMO) transmitter having N transmit antennas, N being at least two, wherein each employs a plurality of transmit symbols with used subcarriers. The method includes generating a set of pilot subcarrier indices and a set of data subcarrier indices for transmission and arranging the sets of pilot subcarrier indices and data subcarrier indices within the used subcarriers during transmission based on the N transmit antennas and the plurality of transmit symbols.

The present invention also provides, in yet another aspect, a multiple-input, multiple-output (MIMO) communication system. The MIMO communication system includes a MIMO transmitter having N transmit antennas, N being at least two, wherein each employs a plurality of transmit symbols with used subcarriers. The MIMO communication system also includes a subcarrier index coordinator that is coupled to the MIMO transmitter and has a subcarrier index generator that generates a set of pilot subcarrier indices and a set of data subcarrier indices for transmission. The subcarrier index coordinator also has a subcarrier index formatter, coupled to the subcarrier index generator, that arranges the sets of pilot subcarrier indices and data subcarrier indices within the used subcarriers during transmission based on the N transmit antennas and the plurality of transmit symbols. The MIMO communication system further includes a MIMO receiver having M receive antennas, M being at least two, that processes the sets of pilot subcarrier indices and data subcarrier indices.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an N×M MIMO communication system constructed in accordance with the principles of the present invention;

FIGS. 2A and 2B illustrate symbol structures that conform to an IEEE 802.11 standard;

FIG. 3 illustrates an embodiment of a symbol structure diagram for two transmit antennas employable with a subcarrier index coordinator and constructed in accordance with the principles of the present invention;

FIG. 4 illustrates an alternative embodiment of a symbol structure diagram for two transmit antennas employable with a subcarrier index coordinator and constructed in accordance with the principles of the present invention; and

FIG. 5 illustrates a flow diagram of an embodiment of a method of coordinating subcarrier indices carried out in accordance with the principles of the present invention.

### DETAILED DESCRIPTION

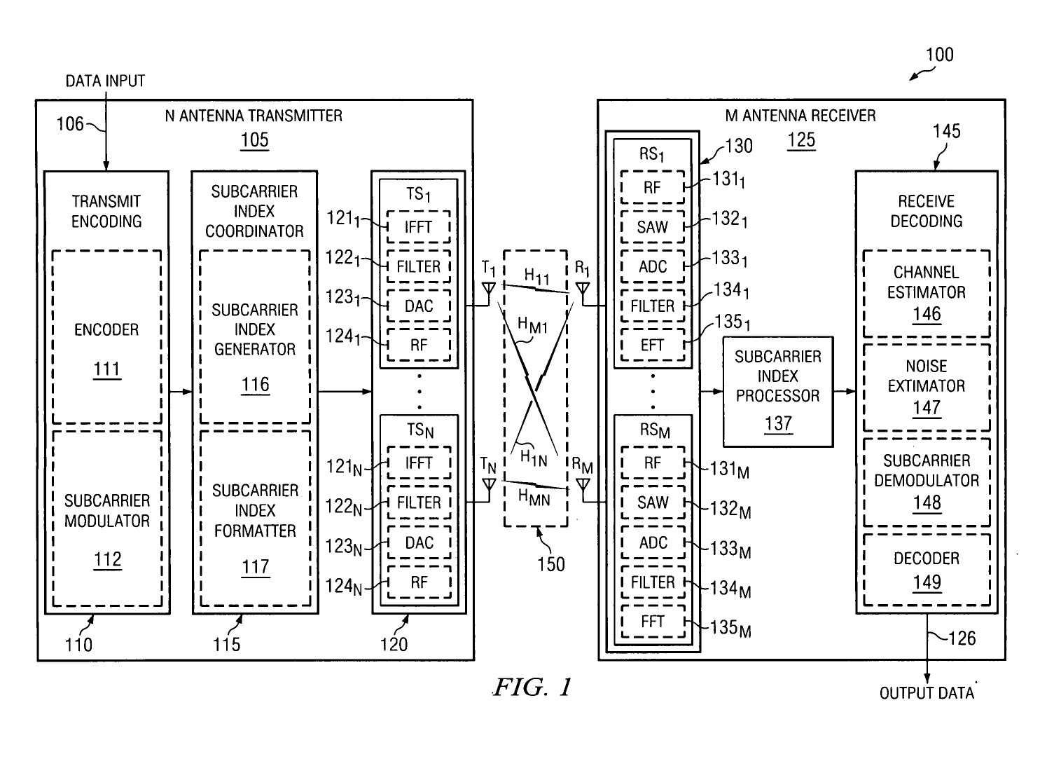

Referring initially to FIG. 1, illustrated is a system diagram of an embodiment of an N×M MIMO communication system, generally designated 100, constructed in accordance with the principles of the present invention. The MIMO communication system 100 includes a MIMO transmitter 105 that provides multiple concurrent data transmissions and a MIMO receiver 125 that receives these transmissions over a communications channel 150.

The MIMO transmitter 105 includes input data 106, a transmit encoding system 110, a subcarrier index coordinator 115, and a transmit system 120 having N transmit sections TS1-TSN coupled to N transmit antennas T1-TN, respectively. The MIMO receiver 125 includes a receive system 130 having M receive sections RS1-RSM respectively coupled to M receive antennas R1-RM, a subcarrier index processor 137 and a receive decoding system 145 providing output data 126. In the embodiment of FIG. 1, N and M are at least two.

The transmit encoding system 110 includes an encoder 111 and a subcarrier modulator 112. The encoder 111 and subcarrier modulator 112 prepare the input data and support the arrangement of preamble and signal information for transmission by the transmit system 120. The subcarrier index coordinator 115 cooperates with the transmit encoding system 110 to generate a set of pilot subcarrier indices and a set of data subcarrier indices to be employed by the MIMO receiver 125 for channel estimation, phase correction and noise variance estimation needed due to changing conditions of the communications channel 150. In the illustrated embodiment, the subcarrier index coordinator 115 may provide a set of pilot subcarrier indices having an arrangement that is either the same for all N transmit antennas, or an arrangement that is different for each of the N transmit antennas.

The N transmit sections TS1-TSN include corresponding pluralities of N IFFT sections 121₁-121_{N}, N filters 122₁-122_{N}, N digital-to-analog converters (DACs) 123₁-123_{N} and N radio frequency (RF) sections 124₁-124_{N}, respectively. The N transmit sections TS1-TSN provide a time domain signal proportional to preamble information, signal information and input data for transmission by the N transmit antennas T1-TN, respectively. The communication system 100 employs channel estimates from each of the transmit antennas T1-TN to each of the receive antennas R1-RM shown generically as H₁₁, H_{M1}, H_{1N}, H_{MN} for the M receive and N transmit antennas. These channel estimates vary during data transmission due to a nomadic channel environment.

The M receive antennas R1-RM receive the transmission and provide it to the M respective receive sections RS1-RSM, which include corresponding M RF sections 131₁-131_{M}, M SAW filters 132₁-132_{M}, M analog-to-digital converters (ADCs) 133₁-133_{M}, M notch filters 134₁-134_{M}, and M Fast Fourier Transform (FFT) sections 135₁-135_{M}, respectively. The M receive sections RS1-RSM employ a proper AGC level to provide a frequency domain digital signal to the receive decoding system 145. This digital signal is proportional to the preamble information, signal information and input data. Setting of the proper AGC level is accomplished by establishing a proper ratio between a desired power level and a received power level for a selected ADC backoff level.

The receive decoding system 145 includes a channel estimator 146, a noise estimator 147, a subcarrier demodulator 148 and a decoder 149 to provide the output data 126. The subcarrier index processor 137 coordinates the set of pilot subcarrier indices and the data subcarrier indices with the channel and noise estimators 146, 147, the subcarrier demodulator 148 and the decoder 149 to provide enhanced channel and noise estimation as well as phase correction during data reception.

The subcarrier index coordinator 115 provides index coordination among the N transmit antennas wherein each transmit antenna employs a plurality of transmit symbols having used subcarriers. The subchannel index coordinator 115 includes a subcarrier index generator 116 and a subcarrier index formatter 117. The subcarrier index generator 116 is configured to generate a set of pilot subcarrier indices and a set of data subcarrier indices for transmission. The subcarrier index formatter 117 is coupled to the subcarrier index generator and is configured to arrange the sets of pilot subcarrier indices and data subcarrier indices within the used subcarriers during transmission based on the N transmit antennas and the plurality of transmit symbols.

In one embodiment, the set of pilot subchannel indices is the same for each of the N transmit antennas. This arrangement complicates the estimation and correction process by introducing the generation of cross-terms in the process. In an alternative embodiment, the pilot subcarrier indices are different for each of the N transmit antennas, which eliminates the generation of cross-terms. As will be discussed further, the set of pilot subcarrier indices is functionally dependent on a transmit antenna number, a subcarrier index number, a pilot number and a symbol number.

The set of pilot subcarrier indices moves sequentially in the used subcarriers for at least a portion of the plurality of transmit symbols. In alternative embodiments, this sequential movement in the used subcarriers may employ steps of adjacent subcarriers, steps of nonadjacent subcarriers, steps of a variable number of subcarriers or steps of subcarriers having different bandwidths. Additionally, the sets of pilot subcarrier indices and data subcarrier indices may employ all of the used subcarriers or only a portion of the used subcarriers for each of the plurality of transmit symbols.

In one embodiment, the set of pilot subcarrier indices is predefined or predetermined in the used subcarriers and the set of data subchannel indices employ the remaining indices. An example of this arrangement is the set of pilot subcarrier indices that conforms to an IEEE 802.11 standard. In an alternative embodiment, the set of data subcarrier indices may be predetermined or predefined in the used subcarriers and the set of pilot subcarrier indices employ the remaining indices.

The subcarrier index coordinator 115 employs a scalable property that allows the accommodation of a MIMO transmitter employing an N of two or more transmit antennas. Correspondingly, the subcarrier index processor 137 allows an associated MIMO receiver, having an M of two or more receive antennas, to also be accommodated to effectively provide appropriate estimation and correction during data transmission for a variety of transmit and receive antennas.

Although appropriate channel estimation is perhaps of primary concern, relative noise from transmit to receive antennas for MIMO systems is also very important. Having known information in the transmitted form of the set of pilot subcarrier indices and the set of data subcarrier indices allows enhanced estimation at the receiver for variances in both channels and noise. Phase correction has a linear component and an offset component that goes across the symbols. So, there will be some offset component of the phase that is constant and then some frequency dependent component. Allowing the pilots to “march” across the set of used subcarrier indices provides better estimates of phase error.

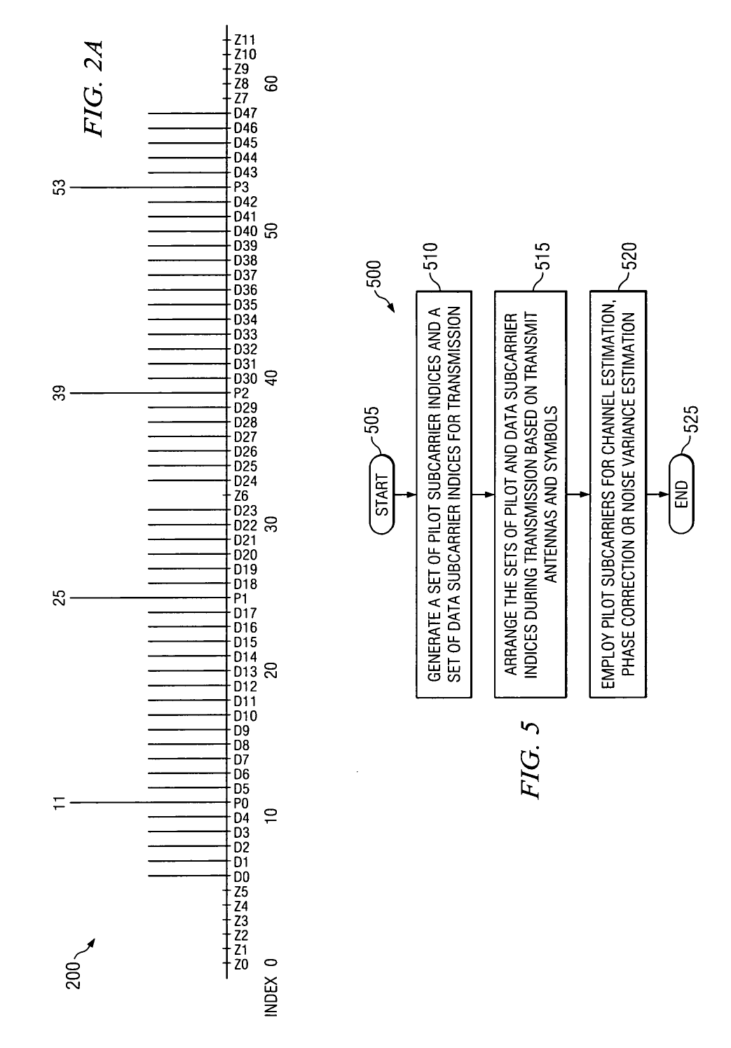

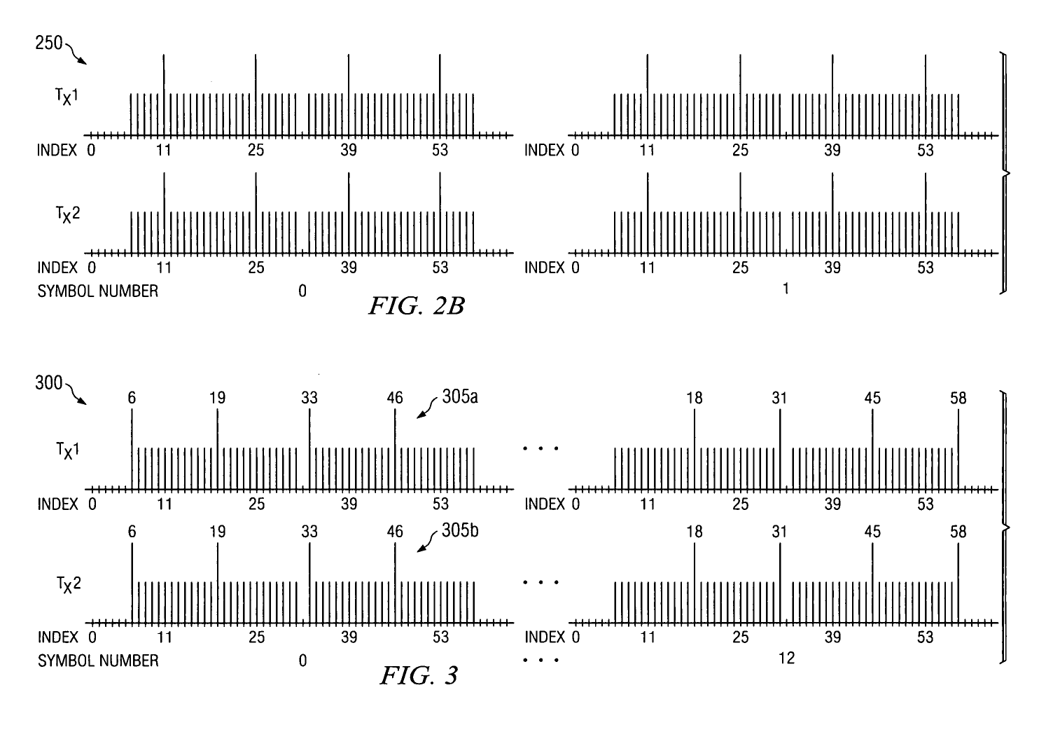

Turning momentarily to FIGS. 2A and 2B, illustrated are symbol structures that conform to an IEEE 802.11 standard. In FIG. 2A, a symbol structure 200 shows a conventional fixed pilot subcarrier and data subcarrier symbol structure that conforms to the IEEE 802.11a specification. The symbol structure 200 includes four fixed pilot subcarriers, 48 fixed data subcarriers, six starting zero subcarriers, one DC zero subcarrier and five ending zero subcarriers yielding a total of 64 subcarriers. The pilot subcarrier indices in the frequency domain are {11,25,39,53} and the data subcarrier indices are {6-10,12-24,26-31,33-38,40-52,54-63} when the left subcarrier index is {0}. An IEEE 802.11a compliant receiver will anticipate this symbol structure.

In FIG. 2B, a symbol structure 250 illustrates a conventional fixed pilot subcarrier symbol structure employing the existing IEEE 802.11a pilot structure and showing symbols “0” and “1” for MIMO first and second transmit antennas Tx1, Tx2. For each symbol in a packet, the pilot subcarrier locations are fixed at the predetermined set of subcarrier indices as shown in FIG. 2A. That is, the pilot subcarriers remain fixed for each symbol in a transmission packet at subcarrier indices {11,25,39,53}. This pilot subcarrier structure requires extrapolation for the data subcarriers located between the pilots subcarriers and readily deteriorates for a changing channel environment.

Returning now to FIG. 1 and as discussed earlier, in current MISO (Multiple Input, Single Output) and MIMO (Multiple Input, Multiple Output) communication systems, the pilot structures are fixed at specific frequency subcarriers and their locations do not change from symbol to symbol. However, significant decoding gain can be achieved in a receiver if the pilot subcarrier indices from a multiple-antenna transmitter are stepped through a set of used subcarrier indices during the transmission.

In general, the set of pilot subcarrier indices, kₚ, for a multiple-antenna transmitter can be expressed as, kₚ=f(a,s,n), where the function f(a,s,n) denotes the dependence on antenna number a, symbol number s and pilot number n. Indirectly, these terms denote the space, time and frequency dependency of the pilot subcarrier indices.

The set of used subcarrier indices, which are the data subcarrier indices and the pilot subcarrier indices and the DC subcarrier for a given transmission, can be denoted as K for a multiple-antenna transmitter. Note that the guard subcarrier indices and the DC subcarrier index are not included in this set. Thus, the set of used subcarrier indices can be expressed as Kε{kₚ,k_{d}}, where k_{d} denotes the set of data subcarrier indices. Note that the set of used subcarrier indices is fixed for a given transmission. However, the set of pilot subcarrier indices can vary as a function of pilot number and symbol number. Thus, the set of data subcarrier indices may be written as k^{d}εK\kₚ, where “\” denotes the complement.

Turning now to FIG. 3, illustrated is an embodiment of a symbol structure diagram for two transmit antennas, generally designated 300, employable with a subcarrier index coordinator and constructed in accordance with the principles of the present invention. The symbol structure diagram 300 includes first and second identical sets of pilot and data subcarrier indices 305a, 305b shown in symbol number 0 that migrate into the positions shown in symbol number 12. In the illustrated embodiment, the pilot subcarrier indices migrate by sequential steps in each of the intermediate symbols 1 through 11 reaching symbol 12, as shown. The initial or starting subcarrier index for each pilot and the span for each pilot (i.e., 13) are based upon the IEEE 802.11a pilot subcarrier design (i.e., 48 data subcarriers and 4 pilot subcarriers) as was discussed with respect to FIG. 2A, for this exemplary embodiment.

Therefore, for each symbol in a packet, the pilot subcarrier indices change in a predefined manner so that a receiver knows the location of pilot subcarriers and data subcarriers. For the two-transmitter example shown in FIG. 3, the pilot subcarrier locations change according to the following mathematical relationship:

$${k}_{p} [ s ] = \{ \begin{matrix}6 + s mod ( 13 ) for pilot \#1 \\ 19 + s mod ( 13 ) for pilot \#2 \\ 33 + s mod ( 13 ) for pilot \#3 \\ 46 + s mod ( 13 ) for pilot \#4 \end{matrix} \qquad ( 1 )$$

where kₚ denotes the set of pilot subcarrier indices for a particular symbol, s denotes the symbol number and mod( ) denotes the modulo operation. As a result, the data subcarrier indices become a function of the symbol number as well.

Stepping the pilot subcarrier indices through the set of subcarrier indices allows known information to migrate through the subcarriers thereby improving the estimation process. This action makes the interpolation process easier. If the pilots are shifted quickly enough, the need for interpolation may be essentially eliminated. Usually, however, a weighted interpolation over space and time (a two-dimension interpolation) is used to improved the accuracy and therefore effectiveness of the estimation process. This allows time interpolation and frequency interpolation for a given receive antenna, which represents a space portion, and also allows filter designs to better reject or suppress noise.

In order to simplify processing in a receiver, corresponding pilot subcarriers may employ a different arrangement or structure that decouples each of the channel estimates. This action thereby eliminates cross-terms and simplifies the computations. Generally, the pilot subcarrier indices have an initial starting subcarrier index and an indexing that is a function of symbol number, as discussed previously. Additionally, frequency spacing of the pilot subcarriers may be different with transmit antenna and with time. That is, there is no restriction that the pilot subcarriers have to be the same spacing from transmit antenna to transmit antenna. However, the spacing within a symbol is typically constant.

In the embodiment of FIG. 3, the pilot subcarrier indices for the first and second transmit antennas Tx1, Tx2 are shown synchronized together. However, in the general case, they may occur asynchronously between transmit antennas. Of course, as the pilot subcarrier indices change with each symbol, the data subcarrier indices also change correspondingly thereby maintaining a communication throughput rate, since the ratio of the number of pilot subcarriers to the number of data subcarriers has not changed.

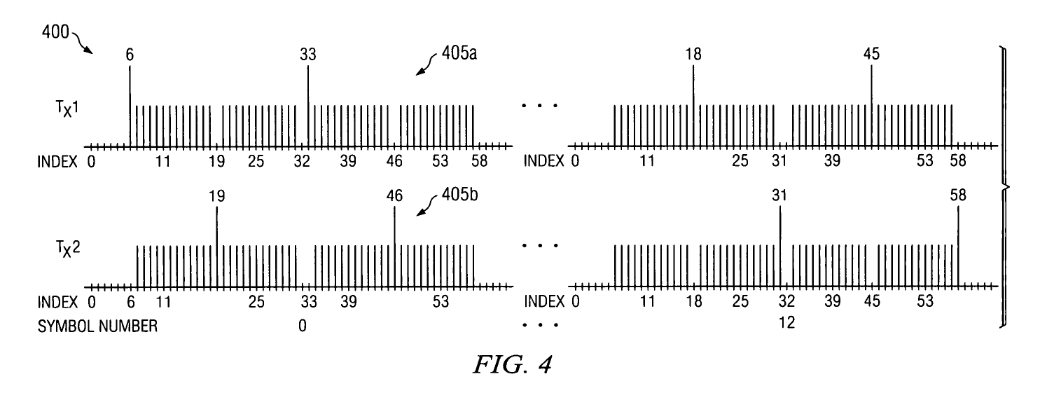

Turning now to FIG. 4, illustrated is an alternative embodiment of a symbol structure diagram for two transmit antennas, generally designated 400, employable with a subcarrier index coordinator and constructed in accordance with the principles of the present invention. The symbol structure diagram 400 includes first and second sets of pilot and data subcarrier indices 405a, 405b shown in symbol number 0 that again migrate into the positions shown in symbol number 12. In the illustrated embodiment, the sets of pilot and data subcarrier indices 405a, 405b also migrate the pilot subcarrier indices by sequential steps in each of the intermediate symbols 1 through 11 reaching symbol 12, as shown. There are generally many ways in which to migrate the pilot subcarrier indices through the set of used subcarrier indices to achieve the same purpose. The example shown in the illustrated embodiment of FIG. 4 employs a different arrangement for the two transmit antennas Tx1, Tx2, which allows the characteristics for each individual channel to be determined independently.

FIG. 4 illustrates a symbol structure diagram where only two pilots are used for each transmit path. The pilot subcarrier indices for transmit antenna Tx1 are defined by the following mathematical relationship:

$${k}_{p} [ s ] = \{ \begin{matrix}6 + s mod ( 13 ) for pilot \#1 \\ 33 + s mod ( 13 ) for pilot \#2\end{matrix} \qquad ( 2 )$$

The pilot subcarrier indices for transmit antenna Tx2 are defined by a similar mathematical relationship:

$${k}_{p} [ s ] = \{ \begin{matrix}19 + s mod ( 13 ) for pilot \#1 \\ 46 + s mod ( 13 ) for pilot \#2 \end{matrix} \qquad ( 3 )$$

Generally, the set of pilot subcarrier indices employs a “null transmission” in corresponding subcarriers associated with all other transmit antennas that are not transmitting a pilot subcarrier, as shown in FIG. 4. This arrangement allows a receiver to know which transmit antenna actually transmitted the pilot and also maintains a given throughput data rate while providing differentiated channel estimation performance.

Turning now to FIG. 5, illustrated is a flow diagram of an embodiment of a method of coordinating subcarrier indices, generally designated 500, carried out in accordance with the principles of the present invention. The method 500 is for use with a MIMO transmitter having N transmit antennas, where N is at least two, wherein each employs a plurality of transmit symbols with used subcarriers and starts in a step 505. Then, in a step 510, a set of pilot subcarrier indices and a set of data subcarrier indices are generated for transmission from the N transmit antennas.

In one embodiment, the set of pilot subcarrier indices conforms to an IEEE 802.11 standard. In alternative embodiments, the set of pilot subcarrier indices may be selected as appropriate to a particular application. For example, the set of pilot subcarrier indices may be the same for each of the N transmit antennas. Alternatively, the set of pilot subcarrier indices may be different for each of the N transmit antennas. Generally, each of the set of pilot subcarrier indices is functionally dependent on at least one of the quantities selected from the group consisting of a transmit antenna number, a subcarrier index number, a pilot number and a symbol number.

In a step 515, the sets of pilot subcarrier indices and data subcarrier indices are arranged within the used subcarriers during transmission based on the N transmit antennas and the plurality of transmit symbols. Generally, the set of pilot subcarrier indices moves sequentially in the used subcarriers for at least a portion of the plurality of transmit symbols. In one embodiment, the set of pilot subcarrier indices moves sequentially employing steps of adjacent subcarriers. In an alternative embodiment, the set of pilot subcarrier indices moves sequentially employing steps of nonadjacent subcarriers. In yet another embodiment, the set of pilot subcarrier indices moves sequentially employing steps of a variable number of subcarriers. In still another embodiment, the set of pilot subcarrier indices moves sequentially employing steps of subcarriers that have different bandwidths.

In one case, the set of pilot subcarrier indices is predetermined or predefined in the used subcarriers, and the set of data subcarrier indices is then employed to occupy at least a portion of the remaining used subcarriers. In another case, the set of data subcarrier indices is predetermined in the used subcarriers, and the set of pilot subcarrier indices is then employed to occupy at least a portion of the remaining used subcarriers. Of course, the sets of pilot subcarrier indices and data subcarrier indices may employ all of the used subcarriers for each of the plurality of transmit symbols.

Then, in a step 520, the set of pilot subcarrier indices and the set of data subcarrier indices are employed for channel estimation, phase correction or noise variance estimation. The method 500 ends in a step 525.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a subcarrier index coordinator, a method of coordinating subcarrier indices and a MIMO communication system employing the coordinator or the method have been presented. Advantages include improvements in the performance of channel estimation, phase correction and noise variance estimation algorithms since training symbols are available at each data subcarrier instead of relying on interpolation.

Although the present invention has been described in detail, those skilled in the art should understand that they can make various changes, substitutions and alterations herein without departing from the spirit and scope of the invention in its broadest form.

What is claimed is:

1. A subcarrier index coordinator for use with a multiple-input, multiple-output (MIMO) transmitter having N transmit antennas, N being at least two, wherein each employs a plurality of transmit symbols with used subcarriers, comprising:
a subcarrier index generator configured to generate a set of pilot subcarrier indices and a set of data subcarrier indices for transmission; and
a subcarrier index formatter coupled to said subcarrier index generator and configured to arrange said sets of pilot subcarrier indices and data subcarrier indices within said used subcarriers during transmission based on said N transmit antennas and said plurality of transmit symbols.

2. The coordinator as recited in claim 1 wherein each of said set of pilot subcarrier indices is functionally dependent on at least one selected from the group consisting of:
a transmit antenna number;
a subcarrier index number;
a pilot number; and
a symbol number.

3. The coordinator as recited in claim 1 wherein said set of pilot subcarrier indices are the same for each of said N transmit antennas.

4. The coordinator as recited in claim 1 wherein said set of pilot subcarrier indices are different for each of said N transmit antennas.

5. The coordinator as recited in claim 1 wherein said set of pilot subcarrier indices moves sequentially in said used subcarriers for at least a portion of said plurality of transmit symbols.

6. The coordinator as recited in claim 5 wherein said set of pilot subcarrier indices moves sequentially employing steps of adjacent subcarriers.

7. The coordinator as recited in claim 5 wherein said set of pilot subcarrier indices moves sequentially employing steps of nonadjacent subcarriers.

8. The coordinator as recited in claim 5 wherein said set of pilot subcarrier indices moves sequentially employing steps of a variable number of subcarriers.

9. The coordinator as recited in claim 5 wherein said set of pilot subcarrier indices moves sequentially employing steps of subcarriers having different bandwidths.

10. The coordinator as recited in claim 1 wherein said sets of pilot subcarrier indices and data subcarrier indices employ all of said used subcarriers for each of said plurality of transmit symbols.

11. The coordinator as recited in claim 1 wherein said set of pilot subcarrier indices is predetermined in said used subcarriers.

12. The coordinator as recited in claim 1 wherein said set of data subcarrier indices is predetermined in said used subcarriers.

13. The coordinator as recited in claim 1 wherein said set of pilot subcarrier indices conforms to an IEEE 802.11 standard.

14. A method of coordinating subcarrier indices for use with a multiple-input, multiple-output (MIMO) transmitter having N transmit antennas, N being at least two, wherein each employs a plurality of transmit symbols with used subcarriers, comprising:
generating a set of pilot subcarrier indices and a set of data subcarrier indices for transmission; and
arranging said sets of pilot subcarrier indices and data subcarrier indices within said used subcarriers during transmission based on said N transmit antennas and said plurality of transmit symbols.

15. The method as recited in claim 14 wherein each of said set of pilot subcarrier indices is functionally dependent on at least one selected from the group consisting of:
a transmit antenna number;
a subcarrier index number;
a pilot number; and
a symbol number.

16. The method as recited in claim 14 wherein said set of pilot subcarrier indices are the same for each of said N transmit antennas.

17. The method as recited in claim 14 wherein said set of pilot subcarrier indices are different for each of said N transmit antennas.

18. The method as recited in claim 14 wherein said set of pilot subcarrier indices moves sequentially in said used subcarriers for at least a portion of said plurality of transmit symbols.

19. The method as recited in claim 18 wherein said set of pilot subcarrier indices moves sequentially employing steps of adjacent subcarriers.

20. The method as recited in claim 18 wherein said set of pilot subcarrier indices moves sequentially employing steps of nonadjacent subcarriers.

21. The method as recited in claim 18 wherein said set of pilot subcarrier indices moves sequentially employing steps of a variable number of subcarriers.

22. The method as recited in claim 18 wherein said set of pilot subcarrier indices moves sequentially employing steps of subcarriers having different bandwidths.

23. The method as recited in claim 14 wherein said sets of pilot subcarrier indices and data subcarrier indices employ all of said used subcarriers for each of said plurality of transmit symbols.

24. The method as recited in claim 14 wherein said set of pilot subcarrier indices is predetermined in said used subcarriers.

25. The method as recited in claim 14 wherein said set of data subcarrier indices is predetermined in said used subcarriers.

26. The method as recited in claim 14 wherein said set of pilot subcarrier indices conforms to an IEEE 802.11 standard.

27. A multiple-input, multiple-output (MIMO) communication system, comprising:
A MIMO transmitter having N transmit antennas, N being at least two, wherein each employs a plurality of transmit symbols with used subcarriers;
a subcarrier index coordinator, coupled to said MIMO transmitter, including:
a subcarrier index generator that generates a set of pilot subcarrier indices and a set of data subcarrier indices for transmission, and
a subcarrier index formatter, coupled to said subcarrier index generator, that arranges said sets of pilot subcarrier indices and data subcarrier indices within said used subcarriers during transmission based on said N transmit antennas and said plurality of transmit symbols; and
a MIMO receiver having M receive antennas, M being at least two, that processes said sets of pilot subcarrier indices and data subcarrier indices.

28. The system as recited in claim 27 wherein each of said set of pilot subcarrier indices is functionally dependent on at least one selected from the group consisting of:
a transmit antenna number;
a subcarrier index number;
a pilot number; and
a symbol number.

29. The system as recited in claim 27 wherein said set of pilot subcarrier indices are the same for each of said N transmit antennas.

30. The system as recited in claim 27 wherein said set of pilot subcarrier indices are different for each of said N transmit antennas.

31. The system as recited in claim 27 wherein said set of pilot subcarrier indices moves sequentially in said used subcarriers for at least a portion of said plurality of transmit symbols.

32. The system as recited in claim 31 wherein said set of pilot subcarrier indices moves sequentially employing steps of adjacent subcarriers.

33. The system as recited in claim 31 wherein said set of pilot subcarrier indices moves sequentially employing steps of nonadjacent subcarriers.

34. The system as recited in claim 31 wherein said set of pilot subcarrier indices moves sequentially employing steps of a variable number of subcarriers.

35. The system as recited in claim 31 wherein said set of pilot subcarrier indices moves sequentially employing steps of subcarriers having different bandwidths.

36. The system as recited in claim 27 wherein said sets of pilot subcarrier indices and data subcarrier indices employ all of said used subcarriers for each of said plurality of transmit symbols.

37. The system as recited in claim 27 wherein said set of pilot subcarrier indices is predetermined in said used subcarriers.

38. The system as recited in claim 27 wherein said set of data subcarrier indices is predetermined in said used subcarriers.

39. The system as recited in claim 27 wherein said set of pilot subcarrier indices conforms to an IEEE 802.11 standard.
